(19) United States
(12) Patent Application Publication
(10) Pub. No.: US 2023/0112445 A1
(43) Pub. Date: Apr. 13, 2023

(54) METHOD AND APPARATUS FOR TRANSMITTING UPLINK CHANNEL FOR RANDOM ACCESS IN WIRELESS COMMUNICATION SYSTEM

(71) Applicant: Samsung Electronics Co., Ltd., Gyeonggi-do (KR)

(72) Inventors: Junyung YI, Gyeonggi-do (KR); Youngbum KIM, Gyeonggi-do (KR); Hyunseok RYU, Gyeonggi-do (KR); Heedon GHA, Gyeonggi-do (KR); Taehan BAE, Gyeonggi-do (KR); Kyungjun CHOI, Gyeonggi-do (KR)

(21) Appl. No.: 17/963,630

(22) Filed: Oct. 11, 2022

(30) Foreign Application Priority Data
Oct. 8, 2021 (KR) 10-2021-0134207

(51) Int. Cl. H04W 52/24; H04L 1/08

(52) U.S. Cl. CPC H04W 52/245; H04W 52/242; H04L 1/08

(57) ABSTRACT

The disclosure relates to a communication technique for converging IoT technology with 5G communication systems designed to support a higher data transfer rate beyond 4G systems, and a system therefor. The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. The disclosure provides a method for improving the coverage of an uplink channel with respect to uplink transmission.

### CROSS-REFERENCE TO RELATED APPLICATION(S)

This application is based on and claims priority under 35 U.S.C. § 119 to Korean Patent Application No. 10-2021-0134207, filed on Oct. 8, 2021, in the Korean Intellectual Property Office, the disclosure of which is incorporated herein by reference in its entirety.

### BACKGROUND

### 1. Field

The disclosure relates generally to a wireless communication system, and more particularly, to a method and apparatus for transmitting and receiving an uplink (UL) channel when a base station or a user equipment (UE) performs random access in a wireless communication system.

### 2. Description of Related Art

To meet the demand for wireless data traffic having increased since deployment of fourth generation (4G) communication systems, efforts have been made to develop an improved fifth generation (5G) or pre-5G communication system. Therefore, the 5G or pre-5G communication system is also referred to as a beyond 4G network communication system or a post long term evolution (LTE) system. The 5G communication system defined by the third generation partnership project (3GPP) is referred to as a new radio (NR) system. The 5G communication system is considered to be implemented in ultrahigh frequency millimeter wave (mmWave) bands, such as sixty gigahertz (60 GHz bands) so as to accomplish higher data rates. To decrease propagation loss of the radio waves and increase the transmission distance in the ultrahigh frequency bands, beamforming, massive multiple-input multiple-output (MIMO), full dimensional MIMO (FD-MIMO), array antenna, analog beam forming, large scale antenna techniques have been researched in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and quadrature amplitude modulation (FQAM) and sliding window superposition coding (SWSC) as advanced coding modulation (ACM), and filter bank multi carrier (FBMC), non-orthogonal multiple access (NOMA), and sparse code multiple access (SCMA) as advanced access technologies have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as sensing technology, wired/wireless communication and network infrastructure, service interface technology, and security technology have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

Thus, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud RAN as the above-described big data processing technology may also be considered an example of convergence of the 5G technology with the IoT technology.

A review of the development of wireless communication from generation to generation illustrates that the development has mostly been directed to technologies for services targeting humans, such as voice-based services, multimedia services, and data services. It is expected that connected devices which are exponentially increasing after commercialization of 5G communication systems will be connected to communication networks. Examples of things connected to networks may include vehicles, robots, drones, home appliances, displays, smart sensors connected to various infrastructures, construction machines, and factory equipment. Mobile devices are expected to evolve in various formfactors, such as augmented reality glasses, virtual reality headsets, and hologram devices. In order to provide various services by connecting hundreds of billions of devices and things in the 6G era, there have been ongoing efforts to develop improved 6G communication systems, which are referred to as beyond-5G systems.

6G communication systems, which are expected to be implemented approximately by the year 2030, will have a maximum transmission rate of tera (1,000 giga)-level bits per second (bps) and a radio latency of 100 microseconds (100 μsec), and thus will be 50 times as fast as 5G communication systems but have the 1/10 radio latency of the 5G systems.

In order to accomplish such a high data transmission rate and an ultra-low latency, it has been considered to implement 6G communication systems in a terahertz band (for example, 95 GHz to 3 THz bands). It is expected that, due to more severe path loss and atmospheric absorption in the terahertz bands than those in mmWave bands introduced in 5G, a technology capable of securing the signal transmission distance (i.e., coverage) will become more crucial. It is necessary to develop, as major technologies for securing the coverage, multiantenna transmission technologies including radio frequency (RF) elements, antennas, novel waveforms having a better coverage than orthogonal frequency division multiplexing (OFDM), beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling a UL transmission and a downlink (DL) transmission to simultaneously use the same frequency resource at the same time, a network technology for utilizing satellites, high-altitude platform stations (HAPS), and the like in an integrated manner, a network structure innovation technology for supporting mobile nodes B and the like and enabling network operation optimization and automation and the like, a dynamic spectrum sharing technology though collision avoidance based on spectrum use prediction, an artificial intelligence (AI)-based communication technology for implementing system optimization by using AI from the technology design step and internalizing end-to-end AI support functions, and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and between humans and things. Particularly, it is expected that services such as truly immersive extended reality (XR), high-fidelity mobile holograms, and digital replicas could be provided through 6G communication systems. In addition, with enhanced security and reliability, services such as remote surgery, industrial automation, and emergency response will be provided through 6G communication systems, and will be applied to various fields including industrial, medical, automobile, and home appliance fields.

With recent development of 5G/6G communication system, in order to extend cell coverage in an mmWave band, there is a need in the art for a method and apparatus for repeatedly transmitting a UL channel

### SUMMARY

Aspects of the disclosure are to address at least the above-mentioned problems and/or disadvantages and to provide at least the advantages described below.

Accordingly, an aspect of the disclosure is to provide a method for determining and configuring repetitive transmission of PRACH, msg3 PUSCH, and msgA PUSCH to improve the coverage of a UL channel in a random access procedure in a wireless communication system.

Another aspect of the disclosure is to provide a method for obtaining an additional energy gain using the repetitive transmission of PRACH, msg3 PUSCH, and msgA PUSCH, thereby improving the coverage of a UL channel

In accordance with an aspect of the disclosure, a method performed by a UE in a communication system, includes receiving, from a base station, information on a reference signal receive power (RSRP) threshold associated with a message 3 (Msg3) repetition, identifying an RSRP of a downlink pathloss reference, determining whether RSRP repetition is applicable based on the RSRP threshold and the RSRP of the downlink pathloss reference, and transmitting the Msg3 to the base station according to the determination.

In accordance with an aspect of the disclosure, a method performed by a base station in a communication system includes transmitting, to a UE, information on an RSRP threshold associated with a Msg3 repetition, and receiving, from the UE, the Msg3 according to whether RSRP repetition is applicable, wherein it is determined whether the RSRP repetition is applicable based on the RSRP threshold and an RSRP of downlink pathloss reference.

In accordance with an aspect of the disclosure, a UE in a communication system includes a transceiver, and a controller configured to receive, from a base station, information on an RSRP threshold associated with a Msg3 repetition, identify an RSRP of a downlink pathloss reference, determine whether RSRP repetition is applicable based on the RSRP threshold and the RSRP of the downlink pathloss reference, and transmit the Msg3 to the base station according to the determination.

In accordance with an aspect of the disclosure, a base station in a communication system includes a transceiver, and a controller configured to transmit, to a UE, information on an RSRP threshold associated with a Msg3 repetition, and receive, from the UE, the Msg3 according to whether RSRP repetition is applicable, wherein it is determined whether the RSRP repetition is applicable based on the RSRP threshold and an RSRP of a downlink pathloss reference.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain, which is a radio resource domain, in a wireless communication system to which the disclosure is applied;

FIG. 2 illustrates a slot structure considered in a wireless communication system to which the disclosure is applied;

FIG. 3 illustrates a synchronization signal block considered in a wireless communication system to which the disclosure is applied;

FIG. 4 illustrates cases in which a synchronization signal block considered in a wireless communication system to which the disclosure is applied is transmitted in a frequency band of less than or equal to 6 GHz;

FIG. 5 illustrates cases in which a synchronization signal block considered in a wireless communication system to which the disclosure is applied is transmitted in a frequency band of greater than or equal to 6 GHz;

FIG. 6 illustrates cases in which a synchronization signal block according to a subcarrier spacing (SCS) is transmitted within 5 ms in a wireless communication system to which the disclosure is applied;

FIG. 7 illustrates a 4-step random access procedure in a wireless communication system according to an embodiment;

FIG. 8 illustrates a 2-step random access procedure in a wireless communication system according to an embodiment;

FIG. 9 illustrates a method for determining a random access procedure in a wireless communication system according to an embodiment;

FIG. 10 illustrates a procedure for determining repetitive transmission of PRACH, msg3 PUSCH, and msgA PUSCH based on downlink pathloss RSRP in a wireless system according to an embodiment;

FIG. 11 illustrates a process for determining whether to perform repetitive transmission of PRACH/msg3/msgA PUSCH in a wireless communication system according to an embodiment;

FIG. 12 illustrates a process for determining whether to perform msgA PUSCH repetitive transmission based on a random access preamble group type in a wireless communication system according to an embodiment;

FIG. 13 illustrates a process for determining whether to perform PRACH repetitive transmission and msg3 PUSCH repetitive transmission when performing a random access procedure in a wireless communication system according to an embodiment;

FIG. 14 illustrates a process for determining msgA repetitive transmission when performing a random access procedure in a wireless communication system according to an embodiment;

FIG. 15 is a block diagram of a UE according to an embodiment; and

FIG. 16 is a block diagram of a base station according to an embodiment.

### DETAILED DESCRIPTION

Embodiments of the disclosure will be described in detail with reference to the accompanying drawings. Descriptions related to technical contents well-known in the art to which the disclosure pertains and not associated directly with the disclosure will be omitted for the sake of clarity and conciseness.

Similarly, some elements may be exaggerated, omitted, or schematically illustrated. The size of each element does not completely reflect the actual size. In the drawings, identical or corresponding elements are provided with identical reference numerals.

The advantages and features of the disclosure and manners to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference numerals designate the same or like elements. The terms which will be described below are terms defined in consideration of the functions in the disclosure, and may be different according to users, intentions of the users, or customs. Therefore, the definitions of the terms should be made based on the contents throughout the specification.

In the following description, a base station (BS) is an entity that allocates resources to terminals, and may be at least one of a gNode B, an eNode B, a Node B, a wireless access unit, a base station controller, and a node on a network. A terminal may include a UE, a mobile station (MS), a cellular phone, a smartphone, a computer, or a multimedia system capable of performing communication functions. The DL refers to a radio link via which a base station transmits a signal to a terminal, and a UL refers to a radio link via which a terminal transmits a signal to a base station. LTE or LTE-A systems may be described herein by way of example, but the embodiments of the disclosure may also be applied to other communication systems having similar technical backgrounds or channel types. Examples of such communication systems may include 5th generation mobile communication technologies developed beyond LTE-A. Herein, 5G may be the concept that covers the existing LTE, LTE-A, or other similar services. In addition, based on determinations by those skilled in the art, the embodiments of the disclosure may also be applied to other communication systems through some modifications without significantly departing from the scope of the disclosure.

As used herein, a unit refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. The elements and units or may be implemented to reproduce one or more central processing units (CPUs) within a device or a security multimedia card, and the unit may include one or more processors.

Although the embodiments will be described below as an example of a method and device for improving UL coverage when performing a random access procedure, the method and device herein is not limited to the respective embodiments, and may be applied to methods for configuring frequency resources corresponding to other channels, by using all of one or more embodiments or a combination of some embodiments. Therefore, based on determinations by those skilled in the art, the embodiments of the disclosure may be applied to other communication systems through some modifications without significantly departing from the scope of the disclosure. A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-advanced (LTE-A), LTE-pro, high-rate packet data (HRPD) of 3GPP2, ultra-mobile broadband (UMB), IEEE 802.16e, and the like, as well as typical voice-based services.

As an example, an LTE system employs an OFDM scheme in a DL and employs a single carrier frequency division multiple access (SC-FDMA) scheme in a UL. The UL indicates a radio link through which a UE {or a mobile station (MS)} transmits data or control signals to a BS (eNode B), and the DL indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

The eMBB communication aims at providing a data rate higher than that supported by existing LTE, LTE-A, or LTE-pro. For example, in the 5G communication system, eMBB must provide a peak data rate of 20 Gbps in the DL and a peak data rate of 10 Gbps in the UL for a single base station. The 5G communication system must provide an increased user-perceived data rate to the UE, as well as the maximum data rate. In order to satisfy such requirements, improvements are needed in transmission/reception technologies, such as a further enhanced MIMO transmission technique. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the IoT in the 5G communication system. mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, it must support a large number of UEs (e.g., 1,000,000 UEs per square kilometer (UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 16 years, because it is difficult to frequently replace the battery of the UE.

A URLLC, which is a cellular-based mission-critical wireless communication service, may be used for remote control for robots or machines, industrial automation, unmanned aerial vehicles, remote health care, emergency alert, and the like. Thus,

URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and must also assign a large number of resources in a frequency band in order to secure reliability of a communication link.

Three services in the 5G communication system (which may be interchangeably used with 5G system), that is, eMBB, URLLC, and mMTC, may be multiplexed and transmitted in a single system. In this case, different transmission/reception techniques and transmission/reception parameters may be used between services in order to satisfy different requirements of the respective services.

Hereinafter, a frame structure of the 5G system will be described in more detail with reference to the drawings. A wireless communication system to which the disclosure is applied will be described by taking the configuration of the 5G system as an example for convenience of description, but embodiments of the disclosure can be applied in the same or similar manner even in 5G or higher systems or other communication systems to which the disclosure is applicable.

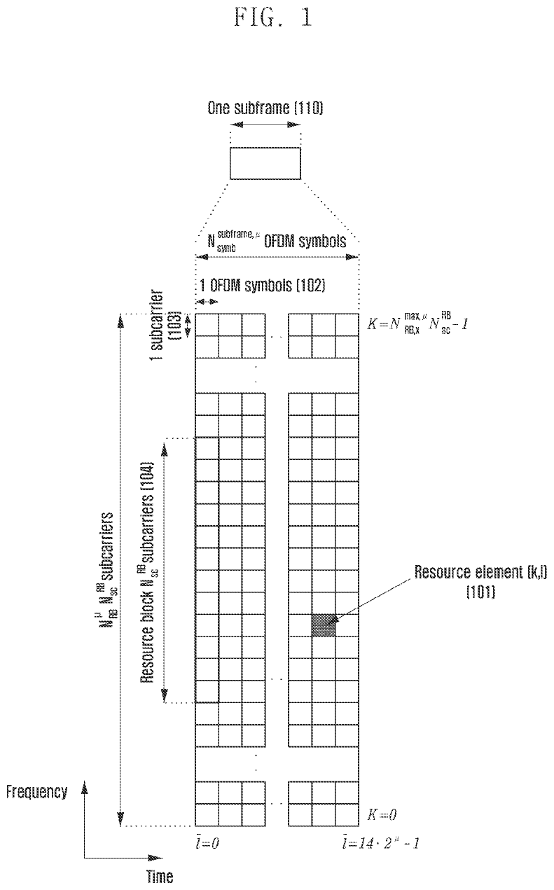

FIG. 1 illustrates a basic structure of a time-frequency domain, which is a radio resource domain, in a wireless communication system to which the disclosure is applied.

In FIG. 1, the horizontal axis indicates a time domain, and the vertical axis indicates a frequency domain. A basic unit of a resource in the time and frequency domain can be defined, as a resource element (RE) 101 by one OFDM symbol (or discrete Fourier transform spread OFDM (DFT-s-OFDM) symbol) 102 on the time axis and one subcarrier 103 on the frequency axis. Consecutive N_{sc}^{RB} REs (for example, 12) indicating the number of subcarriers per resource block (RB) in the frequency domain may constitute one RB 104. In addition, consecutive Nₛₗₒₜ^{subframe} OFDM symbols indicating the number of symbols per subframe in the time domain may constitute one subframe 110.

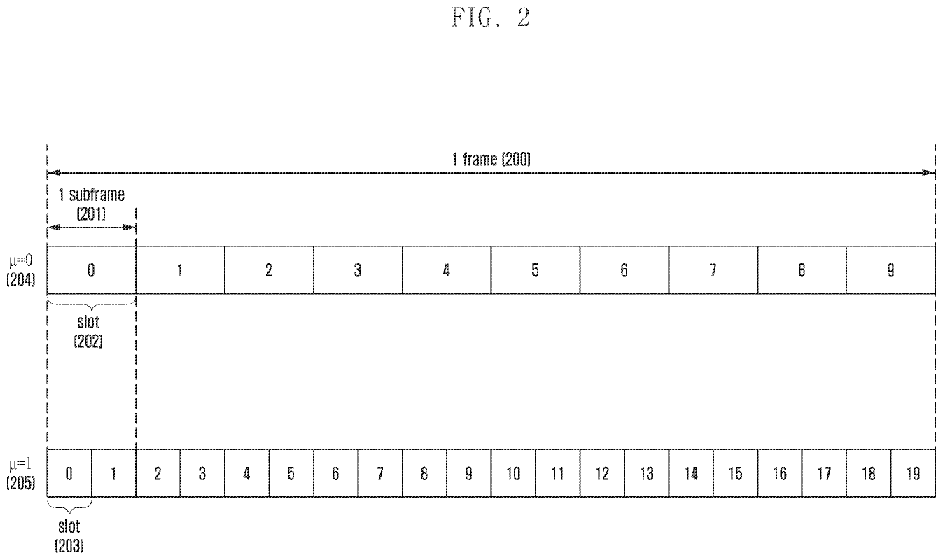

FIG. 2 illustrates a slot structure considered in a wireless communication system to which the disclosure is applied.

FIG. 2 illustrates an example of a structure including a frame 200, a subframe 201, and slots 202 or 203. One frame 200 may be defined as 10 ms. One subframe 201 may be defined as 1 ms, and thus, one frame 200 may include a total of 10 subframes 201. In addition, one slot 202 or 203 may be defined as 14 OFDM symbols (i.e., the number of symbols (N_{symb}^{slot}) per one slot=14). One subframe 201 may include one or multiple slots 202 or 203, and the number of slots 202 or 203 per one subframe 201 may be different according to mu (μ) 204 or 205 which is a configured value of an SCS.

As an example, FIG. 2 illustrates slot structures respectively for μ=0 204 and μ=1 205 as a configured value of an SCS. When μ=0 204, one subframe 201 may include one slot 202, and when μ=1 205, one subframe 201 may include two slots 203. That is, the number of slots (Nₛₗₒₜ^{subframe,μ}) per one subframe may be different according to a configured value μ of an SCS, and accordingly, the number of slots (Nₛₗₒₜ^{frame,μ}) per one frame may be different. The Nₛₗₒₜ^{subframe,μ} and Nₛₗₒₜ^{frame,μ} according to each SCS configured value μ may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G wireless communication system, a synchronization signal block (SSB), which may be interchangeable with an SS block or an SS/physical broadcast channel (SS/PBCH) block, may be transmitted for initial access of a UE, and SSB may include a primary synchronization signal (PSS), a secondary synchronization signal (SSS), and the PBCH. In the initial access step in which the UE accesses a system, the UE first acquires DL time and frequency domain synchronization from a synchronization signal through cell search and then acquires a cell identifier (ID). The SS may include a PSS and an SSS. In addition, the UE receives a PBCH for transmitting a master information block (MIB) from a base station, and acquires a basic parameter value and transmission/reception-related system information, such as a system bandwidth or relevant control information. Based on this information, the UE may perform decoding for a physical downlink control channel (PDCCH) and a physical downlink shared channel (PDSCH) to acquire a system information block (SIB). Thereafter, the UE exchanges identification-related information of the UE with the base station through the random access step and achieves initial accesses to a network through the steps of registration, authentication, and the like.

Hereinafter, a cell initial access procedure in the 5G wireless communication system will be described in more detail with reference to the drawings.

A synchronization signal is a reference signal of the cell search and is transmitted by applying an SCS suitable for a channel environment, such as phase noise, according to each frequency band. A 5G base station may transmit a plurality of SSBs according to the number of analog beams to be operated. For example, a PSS and an SSS may be mapped over 12 RBs to be transmitted, and a PBCH may be mapped over 24 RBs to be transmitted. Hereinafter, a structure in which a synchronization signal and a PBCH are transmitted in the 5G communication system will be described.

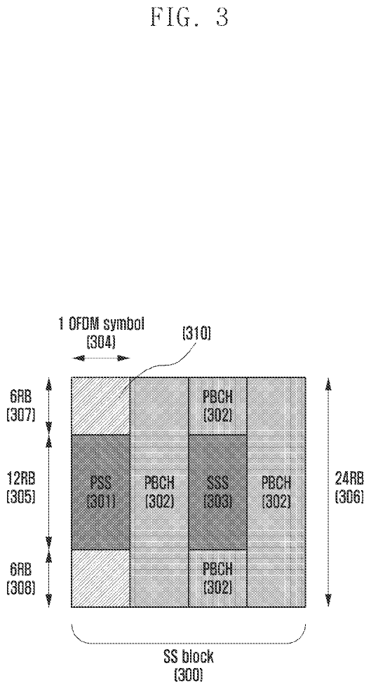

FIG. 3 illustrates an SSB considered in a wireless communication system to which the disclosure is applied.

According to FIG. 3, an SSB (SS block) 300 includes a PSS 301, an SSS 303, and a PBCH 302.

As shown in FIG. 3, SSB 300 is mapped to 4 OFDM symbols 304 on the time axis. The PSS 301 and the SSS 303 may be transmitted from 12 RBs 305 on the frequency axis and respectively from 1st and 3rd OFDM symbols on the time axis. In the 5G system, for example, a total of 1008 different cell IDs may be defined, and the PSS 301 may have 3 different values and the SSS 303 may have 336 different values according to the physical layer IDs of a cell. The UE may acquire one of (336×3=) 1008 cell IDs, based on a combination of the PSS 301 and the SSS 303 through detection thereof. This may be expressed as Equation (1) as follows.

N_{ID}^{cell}=3N_{ID}⁽¹⁾+N_{ID}⁽²⁾ (1)

The N_{ID}⁽¹⁾ may be estimated from the SSS 303 and may have a value between 0 and 335. The N_{ID}⁽²⁾ may be estimated from PSS 301 and may have a value between 0 and 2. The N_{ID}^{(cell)} value, which is a cell ID, may be estimated by the UE from a combination of N_{ID}⁽¹⁾ and N_{ID}⁽²⁾.

The PBCH 302 may be transmitted from a resource including 24 RBs 306 on the frequency axis and 2nd to 4th OFDM symbols of the SS block on the time axis while including 6 RBs 307 and 308 at both sides and excluding 12 central RBs 305 from which the SSS 303 is transmitted. In the PBCH 302, various MIB information may be transmitted, such as information shown below in Table 2, and a PBCH payload and a PBCH demodulation reference signal (DMRS) may include the following additional information.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, |
| | notAllowed}, |
| spare | BIT STRING (SIZE (1)) |
| } | |

Regarding SSB information, an offset in the frequency domain of SSB may be indicated through 4 bits (ssb-SubcarrierOffset) in the MIB. An index of SSB including the PBCH may be indirectly acquired through decoding of the PBCH DMRS and PBCH. More specifically, in the frequency band of less than or equal to less than or equal to 6 GHz, 3 bits acquired through PBCH DMRS decoding may indicate an SSB index, and in the frequency band of greater than or equal to 6 GHz, a total of 6 bits, including 3 bits acquired through PBCH DMRS decoding and 3 bits included in the PBCH payload and acquired through PBCH decoding, may indicate an SSB index including PBCH.

Regarding PDCCH information, an SCS of a common DL control channel may be indicated through 1 bit (subCarrierSpacingCommon) in the MIB, and time-frequency resource configuration information of control resource set (CORESET) and a search space may be indicated through 8 bits (pdcch-ConfigSIB1).

Regarding a system frame number (SFN), 6 bits (systemFrameNumber) in the MIB may be used to indicate a part of SFN. 4 bits (least significant bit (LSB)) of the SFN may be included in the PBCH payload to be indirectly acquired by the UE through PBCH decoding.

regarding timing information in a radio frame, the UE may indirectly identify whether an SSB is transmitted from a 1^{st} or 2^{nd} half frame of a radio frame by 1 bit (a half frame) included in the above-described SSB index and PBCH payload and acquired through PBCH decoding.

Transmission bandwidths (12 RBs 305) of the PSS 301 and the SSS 303 and a transmission bandwidth (24 RBs 306) of the PBCH 302 are different from each other so that 6 RBs 307 and 6 RBs 307 and 308 at both sides of the 1^{st} OFDM symbol from which the PSS 301 is transmitted may exist, except for central 12 RBs 305 from which the PSS 301 is transmitted, within the transmission bandwidth of the PBCH 302, and the 6 RBs 307 and 308 may be used to transmit another signal or may be left empty.

All SSBs may be transmitted using the same analog beam. That is, the PSS 301, the SSS 303, and the PBCH 302 may all be transmitted through the same beam. The analog beam may not be applicable differently on the frequency axis so that the same analog beam may be applied in all RBs on the frequency axis within a particular OFDM symbol to which a particular analog beam is applied. For example, 4 OFDM symbols from which the PSS 301, the SSS 303, and the PBCH 302 are transmitted may all be transmitted through the same analog beam.

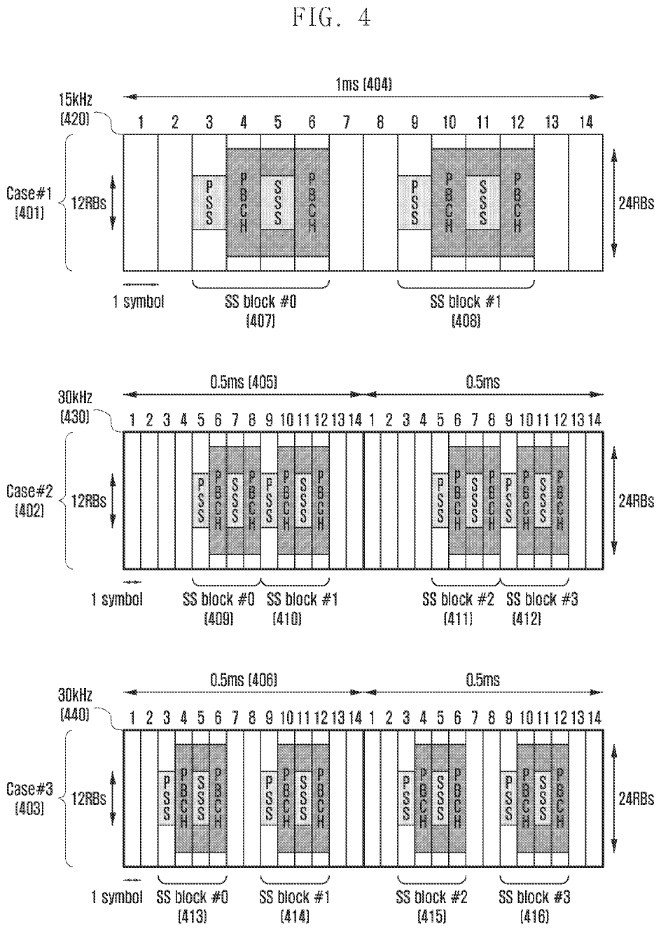

FIG. 4 illustrates various cases in which an SSB considered in a wireless communication system to which the disclosure is applied is transmitted in a frequency band of less than or equal to 6 GHz.

In the 5G communication system, a 15 kHz SCS 420 and 30 kHz SCSs 430 and 440 may be used for SSB transmission in the frequency band of less than or equal to 6 GHz. One transmission case (case #1 401) of SSB may exist for the 15 kHz SCS, and two transmission cases (case #2 402 and case #3 403) of SSB may exist for the 30 kHz SCSs.

In case #1 401 of the 15 kHz SCS 420, a maximum of two SSBs may be transmitted within 1 ms 404 (or corresponding to a length of 1 slot when 1 slot includes 14 OFDM symbols). FIG. 4 illustrates an SSB #0 407 and a SSB #1 408. For example, SSB#0 407 may be mapped to 4 consecutive symbols from a 3^{rd} OFDM symbol, and SSB#1 408 may be mapped to 4 consecutive symbols from a 9^{th} OFDM symbol.

Different analog beams may be applied to SSB #0 407 and SSB #1 408. In addition, the same beam may be applied to 3^{rd} to 6^{th} OFDM symbols to which SSB #0 407 is mapped, and the same beam may be applied to 9^{th} to 12^{th} OFDM symbols to which SSB#1 408 is mapped. Analog beam to be used with respect to the 7^{th}, 8^{th}, 13^{th}, and 14^{th} OFDM symbols to which no SSB is mapped may be freely determined under the determination of a base station.

In case #2 402 of the 30 kHz SCS 430, a maximum of 2 SSBs may be transmitted within 0.5 ms 405 (or corresponding to a length of 1 slot when 1 slot includes 14 OFDM symbols), and accordingly, a maximum of 4 SSBs may be transmitted within 1 ms (or corresponding a length of 2 slots when 1 slot includes 14 OFDM symbols). As an example, FIG. 4 illustrates when SSB #0 409, SSB #1 410, SSB #2 411, and SSB #3 412 are transmitted within 1 ms (i.e., 2 slots). At this time, SSB #0 409 and SSB #1 410 may be mapped from a 5^{th} OFDM symbol and a 9^{th} OFDM symbol of a 1^{st} slot, respectively, and SSB #2 411 and SSB #3 412 may be mapped from a 3^{rd} OFDM symbol and a 7^{th} OFDM symbol of a 2^{nd} slot, respectively.

Different analog beams may be applied to SSB #0 409, SSB #1 410, SSB #2 411, and SSB #3 412. The same analog beam may be applied to the 5^{th} to the 8^{th} OFDM symbols of the 1st slot from which SSB #0 409 is transmitted, the 9^{th} to the 12^{th} OFDM symbols of the 1st slot from which SSB #1 410 is transmitted, to the 6^{th} symbols of slot from which SSB #2 411 is transmitted, and the 7^{th} to the 10^{th} symbols of slot from which SSB #3 412 is transmitted. Analog beam to be used in the OFDM symbols to which no SSB is mapped may be freely determined under the determination of a base station.

In case #3 403 of the 30 kHz SCS 440, a maximum of 2 SSBs may be transmitted within 0.5 ms 406 (or corresponding to a length of 1 slot when 1 slot includes 14 OFDM symbols), and accordingly, a maximum of 4 SSBs may be transmitted within 1 ms (or corresponding to a length of 2 slots when 1 slot includes 14 OFDM symbols). FIG. 4 illustrates when SSB #0 413, SSB #1 414, SSB #2 415, and SSB #3 416 are transmitted within 1 ms (i.e., 2 slots). At this time, SSB #0 413 and SSB #1 414 may be mapped from OFDM symbol and the 9^{th} OFDM symbol of a 1st slot, respectively, and SSB #2 415 and SSB #3 416 may be mapped from OFDM symbol and the 9^{th} OFDM symbol of a 2^{nd} slot, respectively.

Different analog beams may be used with respect to SSB #0 413, SSB #1 414, SSB #2 415, and SSB #3 416. As described above, the same analog beam may be used in all 4 OFDM symbols from which the respective SSBs are transmitted, and analog beam to be used in the OFDM symbols to which no SSB is mapped may be freely determined under the determination of a base station.

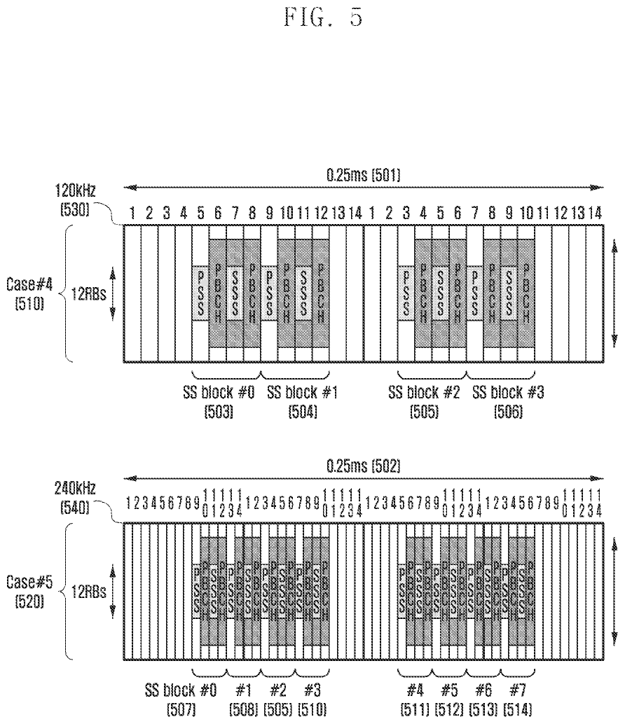

FIG. 5 illustrates cases in which an SSB considered in a wireless communication system to which the disclosure is applied is transmitted in a frequency band of greater than or equal to 6 GHz.

In the frequency band of greater than or equal to 6 GHz in the 5G communication system, a 120 kHz SCS 530 as in the example of case #4 510 may be used for SSB transmission and a 240 kHz SCS 540 as in the example of case #5 520 may be used for SSB transmission.

In case #4 510 of the 120 kHz SCS 530, a maximum of 4 SSBs may be transmitted within 0.25 ms 501 (or corresponding to a length of 2 slots when 1 slot includes 14 OFDM symbols). FIG. 5 illustrates when SSB #0 503, SSB #1 504, SSB #2 505, and SSB #3 506 are transmitted within 0.25 ms (i.e., 2 slots). At this time, SSB #0 503 and SSB #1 504 may be mapped to 4 consecutive symbols from the 5^{th} OFDM symbol of the 1^{st} slot and to 4 consecutive symbols from the 9^{th} OFDM symbol of the 1^{st} slot, respectively. In addition, SSB #2 505 and SSB #3 506 may be mapped to 4 consecutive symbols from OFDM symbol of slot and to 4 consecutive symbols from the 7^{th} OFDM symbol of slot, respectively.

As described above, different analog beams may be used in SSB #0 503, SSB #1 504, SSB #2 505, and SSB #3 506. In addition, the same analog beam may be used in all 4 OFDM symbols from which the respective SSBs are transmitted, and analog beam to be used in the OFDM symbols to which no SSB is mapped may be freely determined under the determination of a base station.

In case #5 520 of a 240 kHz SCS 540, a maximum of 8 SSBs may be transmitted within 0.25 ms 502 (or corresponding to a length of 4 slots when 1 slot includes 14 OFDM symbols). The example of FIG. 5 illustrates when SSB #0507, SSB #1 508, SSB #2 509, SSB #3 510, SSB #4 511, SSB #5 512, SSB #6 513, and SSB #7 514 are transmitted within 0.25 ms 502 (i.e., 4 slots). At this time, SSB #0 507 and SSB #1 508 may be mapped to 4 consecutive symbols from the 9^{th} OFDM symbol of the 1^{st} slot and to 4 consecutive symbols from the 13^{th} OFDM symbol of the 1^{st} slot, SSB #2 509 and SSB #3 510 may be mapped to 4 consecutive symbols from OFDM symbol of slot and to 4 consecutive symbols from the 7^{th} OFDM symbol of slot, SSB #4 511, SSB #5 512, and SSB #6 513 may be mapped to 4 consecutive symbols from the 5^{th} OFDM symbol of slot, to 4 consecutive symbols from the 9^{th} OFDM symbol of slot, and to 4 consecutive symbols from the 13^{th} OFDM symbol of slot, respectively, and SSB #7 514 may be mapped to 4 consecutive symbols from OFDM symbol of slot.

As described above, different analog beams may be used in SSB #0 507, SSB #1 508, SSB #2 509, SSB #3 510, SSB #4 511, SSB #5 512, SSB #6 513, and SSB #7 514. In addition, the same analog beam may be used in all 4 OFDM symbols from which the respective SSBs are transmitted, and analog beam to be used in the OFDM symbols to which no SSB is mapped may be freely determined under the determination of a base station.

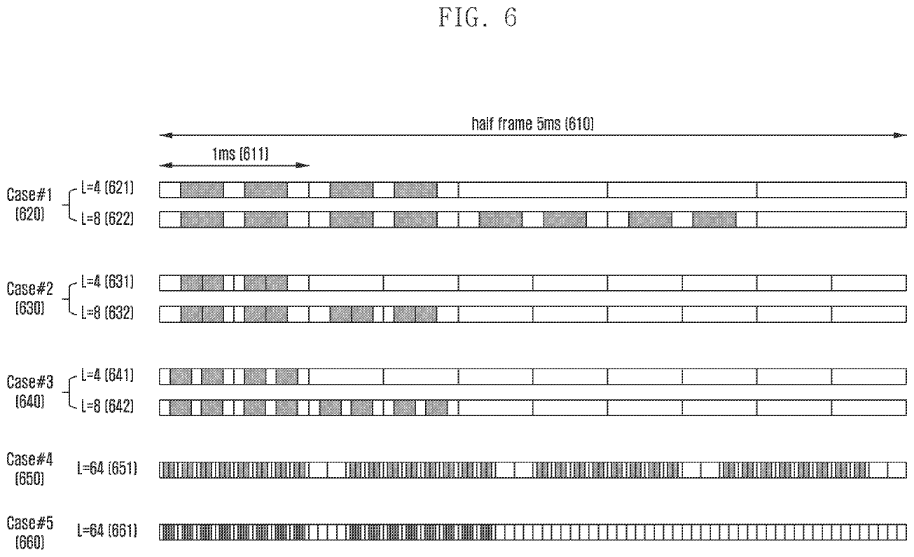

FIG. 6 illustrates cases in which an SSB according to an SCS is transmitted within 5 ms in a wireless communication system to which the disclosure is applied.

In the 5G communication system, an SSB may be periodically transmitted by a unit of 5 ms (corresponding to 5 subframes or a half frame 610).

In a frequency band of less than or equal to 3 GHz, a maximum of 4 SSBs may be transmitted within 5 ms 610. A maximum of 8 SSBs may be transmitted in a frequency band higher than 3 GHz and less than or equal to 6 GHz. A maximum of 64 SSBs may be transmitted in the frequency band of higher than 6 GHz. As described above, the 15 kHz SCS and the 30 kHz SCS may be used at frequency of less than or equal to 6 GHz.

As shown in an example of FIG. 6, in case #1 401 of the 15 kHz SCS configured by 1 slot of FIG. 4, SSBs may be mapped to the 1^{st} slot and slot in a frequency band of less than or equal to 3 GHz, thereby transmitting a maximum of 4 SSBs 621, and SSBs may be mapped to the 1^{st}, 2^{nd}, 3^{rd}, and 4^{th} slots in a frequency band higher than 3 GHz and less than or equal to 6 GHz, thereby transmitting a maximum of 8 SSBs 622. In case #2 402 or case #3 403 of the 30 kHz SCS configured by 2 slots of FIG. 4, SSBs may be mapped starting from the 1^{st} slot in a frequency band of less than or equal to 3 GHz, thereby transmitting a maximum of 4 SSBs 631 and 641, and SSBs may be mapped starting from the 1^{st} and 3^{rd} slots in a frequency band greater than 3 GHz and less than or equal to 6 GHz, thereby transmitting a maximum of 8 SSBs 632 and 642.

The 120 kHz SCS and the 240 kHz SCS may be used at frequencies greater than 6 GHz. As shown in FIG. 6, in case #4 510 of the 120 kHz SCS configured by 2 slots of FIG. 5, SSBs may be mapped starting from the 1^{st}, 3^{rd}, 5^{th}, 7^{th}, 11^{th}, 13^{th}, 15^{th}, 17^{th}, 21^{st}, 23^{rd},25^{th}, 27^{th}, 31^{st}, 33^{rd}, 35^{th}, and 37^{th} slots in a frequency band greater than 6 GHz, thereby transmitting a maximum of 64 SSBs 651. As shown in FIG. 6, in case #5 520 of the 240 kHz SCS configured by 4 slots of FIG. 5, SSBs may be mapped starting from the 1^{st}, 5^{th}, 9^{th},13^{th}, 21^{st}, 25^{th}, 29^{th}, and 33^{rd} slots in a frequency band greater than 6 GHz, thereby transmitting a maximum of 64 SSBs 661.

The UE may acquire an SIB after decoding the PDCCH and the PDSCH, based on the system information included in the received MIB. The SIB may include at least one of UL cell bandwidth-related information, a random access parameter, a paging parameter, a UL power control-related parameter, and the like.

In general, a UE may form a radio link with a network through a random access procedure, based on system information and synchronization with the network acquired in the cell search process of a cell. A contention-based or contention-free scheme may be used for random access. When the UE performs cell selection and reselection in an initial access step of a cell, for example, contention-based random access scheme may be used for a purpose such as moving from the RRC_IDLE state to the RRC_CONNECTED state. Contention-free random access may be used for re-configuring UL synchronization when DL data arrives, in the case of handover, or in the case of location measurement. Table 3 below illustrates conditions (events) under which a random access procedure is triggered in the 5G system.

```
TABLE 3
- Initial access from RRC_IDLE;
- RRC Connection Re-establishment procedure;
- DL or UL data arrival during RRC_CONNECTED when UL
  synchronisation status is “non-synchronised”;
- UL data arrival during RRC_CONNECTED when there are no PUCCH
  resources for SR available;
- SR failure;
- Request by RRC upon synchronous reconfiguration (e.g. handover);
- Transition from RRC_INACTIVE;
- To establish time alignment for a secondary TAG;
- Request for Other SI;
- Beam failure recovery.
```

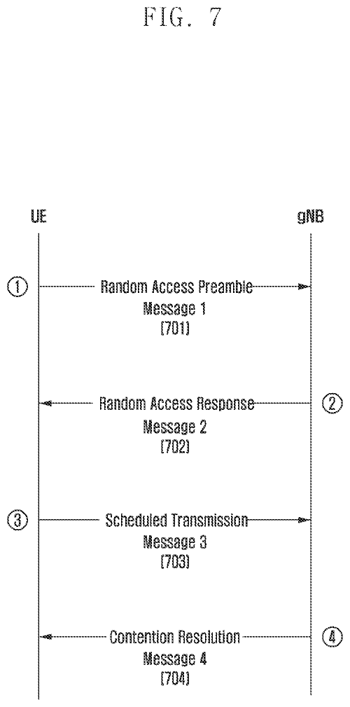

FIG. 7 illustrates a random access procedure in a wireless communication system according to an embodiment.

Referring to FIG. 7, a contention-based random access procedure is illustrated as an example. In addition, the base station may transmit an SSB as described in the above examples. In this case, the base station may periodically transmit SSBs by using beam sweeping. For example, the base station may transmit SSBs including PSS/SSS and PBCH signals by using a maximum of 64 different beams for 5 ms, and the multiple SSBs may be transmitted using different beams. The UE may detect (select) a SSB having an optimal beam direction (e.g., a beam direction in which a received signal strength is strongest or greater than a predetermined threshold) and transmit a preamble using physical random access channel (PRACH) resource related to the detected SSB. For example, in step 701, the UE may transmit a random access preamble (or message 1) to the base station. The base station having received the transmission the random access preamble may measure a transmission delay value between the UE and the base station and adjust UL synchronization. Specifically, the UE may transmit a random access preamble randomly selected within the random access preamble set given by system information in advance. In addition, the initial transmission power of the random access preamble may be determined according to the pathloss between the base station and the UE measured by the UE. The UE may determine the transmission beam direction (or transmission beam or beam) of the random access preamble, based on the SSB received from the base station and transmit the random access preamble by applying the determined transmission beam direction thereto.

In step 702, the base station may transmit a random access response (RAR, or message 2) to the detected random access attempt to the UE. The base station may perform a UL transmission timing control command to the UE, based on the transmission delay value measured from the random access preamble received in step 701. In addition, the base station may transmit a power control command and a UL resource to be used by the UE as scheduling information. The scheduling information may include control information for a UL transmission beam of the UE. The RAR may be transmitted through the PDSCH and may include at least one of a random access preamble sequence index detected by a network (or base station), a temporary cell radio network temporary identifier (TC-RNTI), a UL scheduling grant, and a timing advance value.

When the UE fails to receive the RAR, which is scheduling information for message 3, from the base station for a predetermined time in step 702, the UE may repeat step 701. When the first step is repeated, the UE increases the transmission power of the random access preamble by a predetermined step to transmit the random access preamble (i.e., power ramping), thereby increasing the probability of receiving the random access preamble of the base station.

In step 703, the UE may transmit UL information (scheduled transmission, or message 3) including a UE identifier thereof (i.e., a UE contention resolution identity) (or a valid UE identifier if the UE already has the valid UE identifier (C-RNTI) in the cell before starting the random access procedure) to the base station through the physical uplink shared channel (PUSCH) by using the UL resource allocated in step 702. The transmission timing of the UL data channel for transmitting message 3 may follow the UL transmission timing control command received from the base station in step 702. In addition, the transmission power of the UL data channel for transmitting the message 3 may be determined in consideration of the power ramping value of the random access preamble and the power control command received from the base station in step 702. The UL data channel for transmitting the message 3 may be the first UL data signal transmitted by the UE to the base station after the UE transmits the random access preamble.

Finally, in step 704, when the base station determines that the UE has performed random access without collision with other UEs, the base station may transmit a message (contention resolution message (CR message) or message 4) including an identifier of the UE, which transmitted the UL data in step 703, to the corresponding UE. In this regard, when a plurality of UEs receive the same TC-RNTI in step 702, each of the plurality of UEs received the same TC-RNTI may transmit message 3 including a UE identifier (contention resolution identity) thereof to the base station in step 703, and the base station may transmit message 4 (CR message) including a UE identifier among the plurality of the UE identifiers for contention resolution. When the UE receives message 4 (CR message) including a UE identifier thereof from the base station in step 704 (or when the UE transmits message 3 including a UE identifier (C-RNTI) in step 703 and receives a UE-specific control information including a CRC based on a UE identifier (C-RNTI) thereof through PDCCH in step 704), the UE may determine that random access has been completed successfully. Accordingly, among a plurality of UEs that have received the same TC-RNTI from the base station, a UE which has identified that the UE identifier thereof is included in message 4 (CR message) may identify that random access has been completed successfully. In addition, the UE may transmit HARQ-ACK/NACK indicating whether the message 4 has been successfully received to the base station through a PUCCH.

When the base station fails to receive the data signal from the UE due to collision between the data transmitted by the UE in step 703 and the data from another UE, the base station may end data transmission to the UE. Accordingly, when the UE fails to receive the data transmitted from the base station in step 704 for a predetermined period of time, the UE may determine that the random access procedure has failed and may repeat step 701.

As described above, the UE may transmit random access preamble through a PRACH in the 1st step 701 of the random access procedure. Each cell may have 64 available preamble sequences, and 4 long preamble formats and 9 short preamble formats may be used according to a transmission type. The UE may generate 64 preamble sequences by using a root sequence index and a cyclic shift value signaled through system information, and randomly selects one sequence to use the sequence as a preamble.

The base station may inform the UE of configuration information for the random access resource, for example, control information (or configuration information) indicating time-frequency resources to be usable for PRACH, by using at least one of SIB, higher layer signaling (radio resource control (RRC) information), or downlink control information (DCI). The frequency resource for PRACH transmission may indicate a starting RB point of transmission to the UE, and the number of RBs to be used may be determined according to the preamble format transmitted through the PRACH and the applied SCS. As shown in Table 4 below, the time resource for PRACH transmission may inform preconfigured PRACH configuring cycle, a subframe index and a starting symbol including a PRACH transmission time point (which may be interchangeable with a PRACH occasion and a transmission time point), the number of PRACH transmission time points in a slot, etc., through a PRACH configuration index (0 to 255). Through the PRACH configuration index, the random access configuration information included in the SIB, and the index of the SSB selected by the UE, the UE may confirm the time and frequency resources through which the random access preamble to be transmitted, and transmit the selected sequence as a preamble to the base station.

TABLE 4

| | | | | | | Number of | number of time- | |
|---|---|---|---|---|---|---|---|---|
| PRACH | | | | | | PRACH slots | domain PRACH | |
| configuration | Preamble | | | Subframe | Starting | within a | occasions within | PRACH |
| Index | format | n_{SFN} | | number | symbol | subframe | a PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, 7, 9 | 0 | 2 | 2 | 6 |

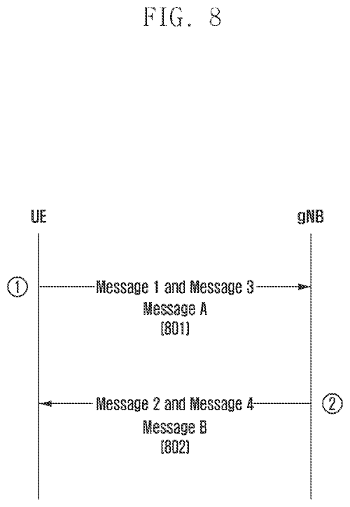

FIG. 8 illustrates a random access procedure (hereinafter, a 2-step RACH procedure) through 2-step signaling in a wireless communication system according to an embodiment.

Referring to FIG. 8, a contention-based random access procedure is illustrated as an example. In addition, the base station may transmit a SSB as described in the above examples. In this case, the base station may periodically transmit an SSB by using beam sweeping. The UE may detect an SSB having an optimal beam direction (e.g., a beam direction in which the received signal strength is greater than a predetermined threshold), and transmit a preamble by using a PRACH resource related to the detected SSB. This is identical to the 4-step RACH procedure described with reference to FIG. 7.

Unlike the 4-step RACH procedure, the UE may perform a random access procedure through 2-step signaling. In step 801, the UE may transmit a message requesting connection to the network. The request message may include a random access preamble and a UE identifier. The message transmitted in step 801 may be referred to as message A, and may include information on message 1 and message 3. In step 802, the UE may receive a response message from the base station. The response message may be a contention resolution message approving a connection request or a message requesting retransmission due to decoding failure. The message transmitted in step 802 may be referred to as message B, and may include information on message 2 and message 4 described in the 4-step RACH procedure.

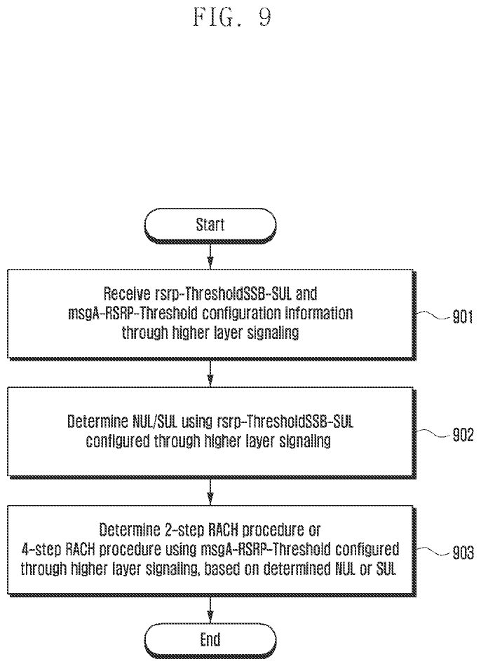

FIG. 9 illustrates a method for determining a random access procedure in a wireless communication system according to an embodiment.

A method for configuring one of the 4-step random access procedure and the 2-step random access procedure, described above, when a UE performs a random access procedure in a wireless system is described with reference to FIG. 9. In step 901, the UE may receive, from the base station, configuration information for a random access procedure including rsrp-ThresholdSSB-SUL and msgA-RSRP-Threshold through higher layer signaling (RRC signaling). In step 902, the UE may determine a carrier on which the UE performs transmission by using the configured rsrp-ThresholdSSB-SUL. More specifically, when the reference signal received power (RSRP) value of the DL pathloss measured by the UE is less than the configured rsrp-ThresholdSSB-SUL, the UE may be operated using a supplementary UL (SUL). Conversely, if the reference signal received power (RSRP) value of the DL pathloss measured by the UE is greater than or equal to the configured rsrp-ThresholdSSB-SUL, the UE may be operated using a normal UL (NUL). In step 903, in the determined UL carrier, the UE may determine a random access procedure using the configured msgA-RSRP-Threshold. More specifically, when the bandwidth part (BWP) selected to perform the random access procedure can support both the 4-step random access procedure and the 2-step random access procedure, and the RSRP of the DL pathloss measured by the UE is greater than the msgA-RSRP-Threshold, the UE may perform a 2-step random access procedure. In addition, when the BWP selected to perform the random access procedure supports only the 2-step random access procedure or a random access procedure for reconfiguring synchronization for the 2-step random access procedure is performed, the UE performs the 2-step random access procedure. In all other cases, the UE performs the 4-step random access procedure.

The disclosure describes a predefined determination method and/or a method for determining using Threshold as a method for determining repetitive transmission of PRACH, msg3 PUSCH, and msgA PUSCH when a random access procedure is performed in a wireless communication system. A method for operating a UE for performing repetitive transmission of PRACH, msg3 PUSCH, and msgA PUSCH, based on repetitive transmission of PRACH, msg3 PUSCH, and msgA PUSCH herein may include receiving, from a base station, configuration information for performing a random access procedure, and determining repetitive transmission of PRACH, msg3 PUSCH, and msgA PUSCH, based on the configuration information for the configured random access procedure received from the base station. A method for operating a base station for performing repetitive transmission of PRACH, msg3 PUSCH, and msgA PUSCH, based on repetitive transmission of PRACH, msg3 PUSCH, and msgA PUSCH herein may include transmitting, to a UE, configuration information for performing a random access procedure.

A procedure and method for determining repetitive transmission of PRACH, msg3 PUSCH, and msgA PUSCH will be described. The disclosure provides a procedure for determining repetitive transmission of PRACH, msg3 PUSCH, and msgA PUSCH in a wireless system.

The method for determining repetitive transmission of PRACH, msg3 PUSCH, and msgA PUSCH herein provides repetitive transmission of PRACH, msg3 PUSCH, and msgA PUSCH, which can improve UL coverage in the random access procedure.

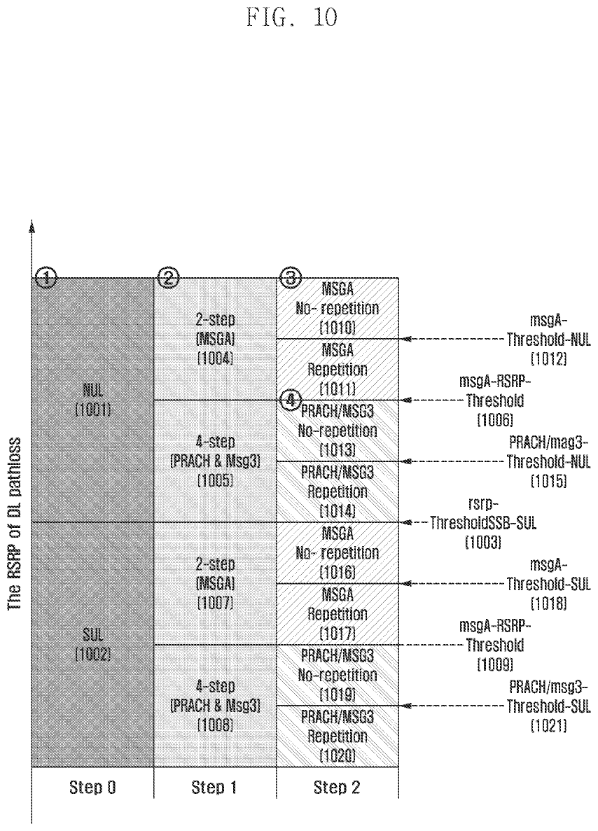

FIG. 10 illustrates a procedure for determining repetitive transmission of PRACH, msg3 PUSCH, and msgA PUSCH based on DL pathloss RSRP in a wireless system according to an embodiment.

Referring to FIG. 10, when the UE receives configuration to perform a random access procedure, the UE may determine a UL carrier by using the RSRP of DL pathloss and then determine the step of the random access procedure. Thereafter, based on the configured carrier and random access procedure, the UE may determine whether to perform repetitive transmission of PRACH, msg3 PUSCH, and msgA PUSCH. More specifically, in step 0 in FIG. 10, NUL or SUL may be determined as a UL carrier by the UE, based on the DL pathloss RSRP. When the pathloss RSRP of the DL is less than the rsrp-ThresholdSSB-SUL 1003 configured through higher layer signaling from the base station, the UE may perform a random access procedure by using an SUL carrier 1002. Otherwise, the UE may perform a random access procedure by using an NUL carrier 1001.

In step 1, the UE may determine the 2-step random access procedure 1004 or 1007 or the 4-step random access procedure 1005 or 1008, based on the pathloss RSRP of the DL and random access configuration information in the corresponding BWP. More specifically, when the BWP for the random access procedure supports the 2-step random access and the pathloss RSRP of the DL is greater than msgA-RSRP-Threshold 1006 or 1009, the UE may apply the 2-step random access. Otherwise, the UE applies the 4-step random access procedure. In this case, the 2-step random access may determine whether to perform msgA repetitive transmission in step 2 through a Threshold or Predefined method. In addition, the 4-step random access may determine whether to perform PRACH repetitive transmission and msg3 PUSCH repetitive transmission individually or simultaneously through a Threshold or Predefined method. Thereafter, the UE may perform transmission (or repetitive transmission) of PRACH, msg3, PUSCH, and msgA PUSCH, based on the determined carrier, random access procedure, and the presence or absence of repetitive transmission. Whether to perform repetitive transmission of PRACH, msg3 PUSCH, and msgA PUSCH may be determined using one or a combination of the Threshold and Predefined methods for determining repetitive transmission of the following PRACH, msg3 PUSCH, and msgA PUSCH.

### Method 1

Method 1 provides a method for determining repetitive transmission of PRACH, msg3 PUSCH, and msgA PUSCH by using a Threshold which is predefined or configured through higher layer signaling. The names of the Threshold used for repetitive transmission of PRACH, msg3 PUSCH, and msgA PUSCH are for illustrative purposes and are not limited thereto.

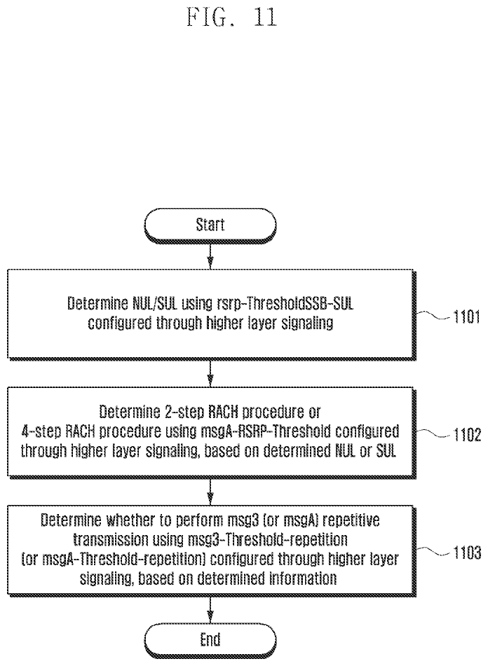

FIG. 11 illustrates a process for determining whether to perform repetitive transmission of PRACH/msg3/msgA PUSCH in a wireless communication system according to an embodiment.

Referring to FIG. 11, the UE may receive random access configuration information and Threshold values for performing random access from the base station through higher layer signaling. Thereafter, the UE may determine NUL or SUL by comparing the measured DL pathloss RSRP and rsrp-ThresholdSSB-SUL in step 1101. Thereafter, different msgA-RSRP-Threshold and msg3-Threshold-repetition may be configured differently according to the determined NUL or SUL. The UE may determine the 4-step random access procedure or the 2-step random access procedure by comparing the msgA-RSRP-Threshold and the DL pathloss RSRP measured based on the determined UL carrier in step 1102. According to the random access procedure, the UE may determine whether to perform msg3 PUSCH repetitive transmission or msgA PUSCH repetitive transmission by using msg3-Threshold-repetition or msgA-Threshold-repetition configured through higher layer signaling in step 1103. For example, when the UE performs 4-step random access procedure, the UE may compare the DL pathloss RSRP and msg3-Threshold-repetition 1015 or 1021, based on the configured random access procedure, to perform msg3 PUSCH repetitive transmission 1014 or 1020 if the DL pathloss RSRP is less than msg3-Threshold-repetition 1015 or 1021, and to perform msg3 PUSCH transmission without repetition 1013 or 1019 if the DL pathloss RSRP is larger than or equal to msg3-Threshold-repetition 1015 or 1021. In addition, when the UE performs the 2-step random access procedure, the UE may compare the DL pathloss RSRP and msgA-Threshold-repetition 1012 or 1018, based on the configured random access procedure, to perform msgA PUSCH repetitive transmission 1011 or 1017 if the DL pathloss RSRP is less than msgA-Threshold-repetition 1012 or 1018, and to perform msgA PUSCH transmission without repetition 1010 or 1016 if the DL pathloss RSRP is less than msgA-Threshold-repetition 1012 or 1018. The method for performing Msg3 PUSCH repetitive transmission may be applied equally as a method for determining PRACH repetitive transmission.

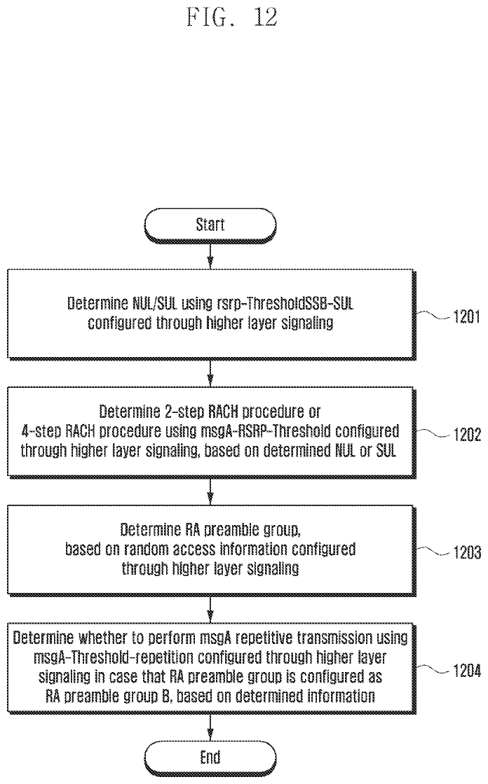

FIG. 12 illustrates a process for determining whether to perform msgA PUSCH repetitive transmission according to a random access preamble group type in a wireless communication system according to an embodiment.

Referring to FIG. 12, the UE may receive random access configuration information and Threshold values for performing random access from the base station through higher layer signaling. Thereafter, the UE may determine NUL or SUL by comparing the measured DL pathloss RSRP and rsrp-ThresholdSSB-SUL in step 1201. Different msgA-RSRP-Threshold and msg3-Threshold-repetition may be configured differently according to the determined NUL or SUL. The UE may determine the 4-step random access procedure or the 2-step random access procedure by comparing the msgA-RSRP-Threshold and the DL pathloss RSRP measured based on the determined UL carrier in step 1202. At this time, when the UE is configured to use the 2-step random access procedure, the UE may determine whether to configure the random access preamble group B in consideration of the pathloss and the size of data (uplink data including MAC subheader) corresponding to msg3 to be transmitted in step 1203. More specifically, the random access preambles group B may be optionally configured to the UE through the base station. At this time, the UE may be configured to use the random access preambles group B when the size of data (uplink data including MAC subheader) corresponding to msg3 to be transmitted is greater than ra-msg3SizeGroupA and the pathloss is less than PCMAX (maximum power applicable in a cell)—‘preambleReceivedTargetPower’—‘msg3-Deltapreable ’—‘messagePowerOffestGroupB’. The transmission power-related variables may be configured through higher layer signaling and may be used to calculate UL transmission power in the random access procedure. When the UE is configured to use the 2-step random access procedure and configured to use the random access preambles group B, the UE may determine whether to perform msgA repetitive transmission by using msgA-Threshold-repetition in step 1204. When the UE is configured to use the random access preamble group A, the UE may not support msgA PUSCH repetitive transmission. The UE may determine whether to perform msgA repetitive transmission according to a random access preamble group as described above. In the above method, the UE being configured to use the random access preambles group B indicates that the size of UL data to be transmitted by the UE in the random access procedure is large, and thus, additional UL coverage improvement may be required. Therefore, the UE configured to use the random access preamble group B may support msgA repetitive transmission. The above method may be equally applied to msg3.

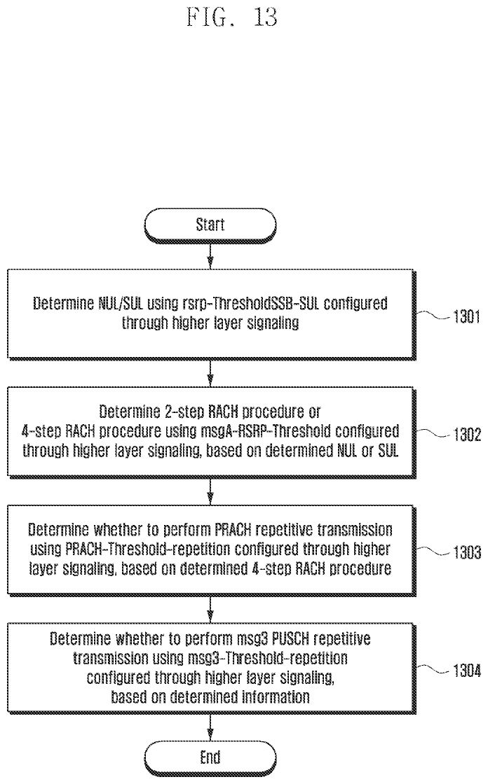

FIG. 13 illustrates a process for determining whether to perform repetitive transmission of PRACH and msg3 PUSCH in a wireless communication system according to an embodiment.

Referring to FIG. 13, the UE may receive random access configuration information and Threshold values for performing random access from the base station through higher layer signaling. Thereafter, the UE may determine NUL or SUL by comparing the measured DL pathloss RSRP and rsrp-ThresholdSSB-SUL in step 1301. Different msgA-RSRP-Threshold and msg3-Threshold-repetition may be configured differently according to the determined NUL or SUL. The UE may determine the 4-step random access procedure or the 2-step random access procedure by comparing msgA-RSRP-Threshold and the DL pathloss RSRP measured based on the determined UL carrier in step 1302. When the UE is configured to use the 4-step random access procedure, the UE may determine whether to perform PRACH repetitive transmission by using the PRACH-Threshold-repetition configured through higher layer signaling in step 1303. The UE may determine whether to perform msg3 PUSCH repetitive transmission by using the msg3-Threshold-repetition configured through higher layer signaling, based on the determination information in step 1304. Each repetitive transmission of PRACH and Msg3 PUSCH may be determined using the method of FIG. 13. Alternatively, in order to reduce the complexity of the procedures 1303 and 1304 of FIG. 13, PRACH-Threshold-repetition and msg3-Threshold-repetition are configured as the same single threshold (PRACH/msg3-Threshold-repetition) and repetitive transmission thereof may be determined simultaneously.

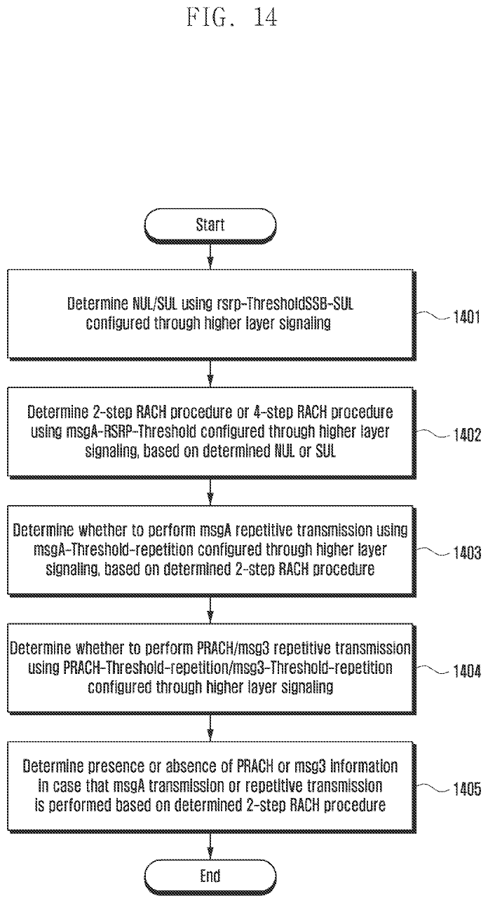

FIG. 14 illustrates a process for determining msgA repetitive transmission when performing a random access procedure in a wireless communication system according to an embodiment.

Referring to FIG. 14, the UE may receive random access configuration information and Threshold values for performing random access from the base station through higher layer signaling. Thereafter, the UE may determine NUL or SUL by comparing the measured DL pathloss RSRP and rsrp-ThresholdSSB-SUL in step 1401. Different msgA-RSRP-Threshold and msg3-Threshold-repetition may be configured differently according to the determined NUL or SUL. The UE may determine the 4-step random access procedure or the 2-step random access procedure by comparing the msgA-RSRP-Threshold and the DL pathloss RSRP measured based on the determined UL carrier in step 1402. In this case, when the UE is configured to use the 2-step random access procedure, the UE may determine the msgA PUSCH repetitive transmission by using the DL pathloss RSRP and msgA-Threshold-repetition in step 1403. The UE may configure information on msgA repetitive transmission by using one of PRACH, msg3, and PRACH+msg3 when performing the msgA repetitive transmission to enable the msgA PUSCH repetitive transmission. To determine the configuration information of the msgA repetitive transmission, the UE may use PRACH-Threshold-repetition/msg3-Threshold-repetition configured through higher layer signaling in step 1404. For example, when the DL pathloss RSRP measured by the UE is less than PRACH-Threshold-repetition and the DL pathloss RSRP is smaller than msg3-Threshold-repetition, msgA repetitive transmission may be performed while including both PRACH +msg3. In addition, when the DL pathloss RSRP measured by the UE is smaller than PRACH-Threshold-repetition and the DL pathloss RSRP is greater than msg3-Threshold-repetition, the first msgA transmission may be performed while including all PRACH+Msg3, and the subsequent msgA repetitive transmission may be performed while including only PRACH. In another method, when the DL pathloss RSRP measured by the UE is greater than PRACH-Threshold-repetition and the DL pathloss RSRP is less than msg3-Threshold-repetition, the first msgA transmission is performed while including both PRACH+Msg3 and the subsequent msgA repetitive transmission may be transmitted while including only msg3 in step 1405). When the same PRACH-Threshold-repetition and msg3-Threshold-repetition are configured in the process of determining the msgA information, the UE may transmit msgA including both PRACH+Msg3 when performing msgA repetitive transmission.

By using Method 1, the UE may apply a method for determining repetitive transmission of PRACH, msg3 PUSCH, and msgA PUSCH, based on Thresholds. Method 1 may be immediately applied when performing an initial random access procedure, to determine whether to perform repetitive transmission of PRACH, msg3 PUSCH, and msgA PUSCH. When the random access procedure through single PRACH, msg3 PUSCH, and msgA PUSCH transmission fails while performing the random access procedure, the UE then may perform repetitive transmission of PRACH, msg3 PUSCH, and msgA PUSCH with reference to information (e.g., with or without support for repetitive transmission of PRACH, msg3 PUSCH, and msgA PUSCH and Threshold for determination on repetitive transmission of PRACH, msg3 PUSCH, and msgA PUSCH) configured through higher layer signaling. Additionally, in Method 1, only comparison with pathloss RSRP is applied as a Threshold for repetitive transmission of PRACH, msg3 PUSCH, and msgA PUSCH, but this is for an example only and does not limit the range. Any Threshold according to the size of PRACH, msg3, and msgA may be additionally applied to determine whether to perform repetitive transmission of PRACH, msg3 PUSCH, and msgA PUSCH. In addition, the Threshold configured through the higher layer signaling may be configured differently according to the NUL/SUL or the 2-step/4-step random access procedure according to the procedure flowchart, and may be used to determine repetitive transmission of PRACH, msg3 PUSCH, and msgA PUSCH. When determining whether to perform repetitive transmission of a PRACH, msg3 PUSCH, or msgA PUSCH due to the failure of a single PRACH, msg3 PUSCH, or msgA PUSCH transmission, PRACH/msg3/msgA-Threshold-repetition may be reconfigured through higher layer signaling and L1 signaling.

### Method 2

Method 2 provides a method for determining repetitive transmission of PRACH, msg3 PUSCH, and msgA PUSCH by using a predefined method.

Referring to FIG. 10 described above, the UE may determine NUL/SUL by using the DL pathloss RSRP and Threshold through 3 steps, determine the 4-step random access procedure/2-step random access procedure, PRACH, and determine whether to perform repetitive transmission of msg3 PUSCH and msgA PUSCH. The UE may apply a predefined method to simplify the determination procedure for repetitive transmission of PRACH, msg3 PUSCH, and msgA PUSCH. For example, the UE may receive random access configuration information and threshold values for performing random access from the base station through higher layer signaling. Thereafter, the UE may determine NUL or SUL by comparing the measured DL pathloss RSRP and rsrp-ThresholdSSB-SUL. Different msgA-RSRP-Threshold and msg3-Threshold-repetition may be configured differently according to the determined NUL or SUL. The UE may determine the 4-step random access procedure or the 2-step random access procedure by comparing msgA-RSRP-Threshold and the DL pathloss RSRP measured based on the determined UL carrier.

The UE may receive on/off configuration information of PRACH/msg3/msgA repetitive transmission from the base station through higher layer signaling. When the UE is configured to be “on” (or enable) with respect to PRACH/msg3/msgA repetitive transmission and is configured to use SUL, through higher layer signaling, the UE may repeat PRACH/msg3/msgA transmission without an additional step 2 procedure 1016, 1017, 1019, or 1020. In the above example, the case in which the UE is configured to use SUL indicates that the coverage of the UL is insufficient. Therefore, PRACH/msg3/msgA repetitive transmission may be applied without an additional procedure, thereby reducing the complexity of the procedure and improving the coverage of the UL.

When the UE is configured to be on (or enabled) with respect to the PRACH/msg3 repetitive transmission and is configured to use NUL, through higher layer signaling, the UE may always perform PRACH/msg3 repetitive transmission when the 4-step random access procedure is applied thereto. When the UE is configured to be on (or enabled) with respect to msgA repetitive transmission and is configured to use NUL, through the higher layer signaling, the UE may repeat msgA transmission only in the random access preamble group B when the 2-step random access procedure is applied thereto. When the UE performs 2-step random access procedure in NUL may indicate that the coverage of the UE is guaranteed. Therefore, the method for determining msgA repetitive transmission according to the size of msgA when the UE performs the 2-step random access procedure in NUL may be an optimized method.

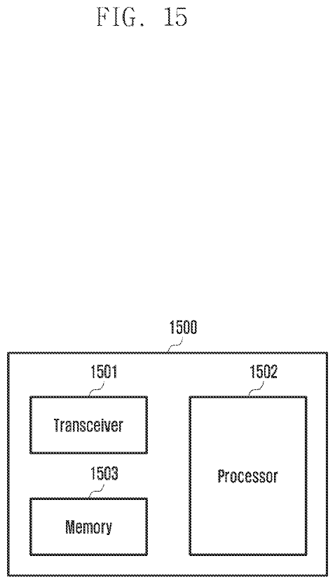

FIG. 15 is a block diagram of a UE according to an embodiment. Referring to FIG. 15, the UE 1500 may include a transceiver 1501, a controller (processor) 1502, and a storage unit (memory) 1503. The transceiver 1501, the controller 1502, and the storage unit 1503 of the UE 1500 may operate according to an efficient method for transmitting and receiving a channel and a signal in the 5G communication system corresponding to the above-described embodiment. However, components of the UE 1500 are not limited to the above-described example, and the UE 1500 may include fewer components than or additional components to the aforementioned components. In addition, the transceiver 1501, the controller 1502, and the storage unit 1503 may be implemented in the form of a single chip.

The transceiver 1501 may also include a transmitter and a receiver that may transmit/receive a signal to/from a base station. The signal may include control information and data. To this end, the transceiver 1501 may include an RF transmitter for up-converting and amplifying a frequency of a transmitted signal, and an RF receiver for low-noise amplifying and down-converting a received signal. In addition, the transceiver 1501 may receive a signal through a wireless channel to output the received signal to the controller 1502 and transmit the signal output from the controller 1502 through a wireless channel.

The controller 1502 may control a series of processes in which the UE 1500 may operate. For example, the controller 1502 may perform or control the operation of the UE for performing a UL channel transmitting method for random access. To this end, the controller 1502 may include a communication processor (CP) for performing control for communication, and an application processor (AP) for controlling a higher layer, such as an application program.

The storage unit 1503 may store data or control information such as information related to channel estimates using DMRS transmitted from the PUSCH contained in a signal obtained from the UE 1500, and may include an area for storing data required for the control by the controller 1502 and data generated during the control by the controller 1502.

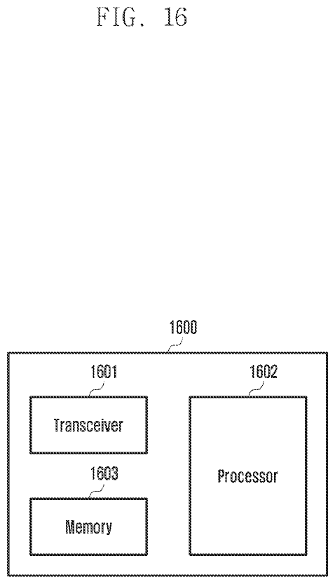

FIG. 16 is a block diagram of a base station according to an embodiment. Referring to FIG. 16, the base station 1600 may include a transceiver 1601, a controller (processor) 1602, and a storage unit (memory) 1603. The transceiver 1601, the controller 1602, and the storage unit 1603 of the base station 1600 may operate according to an efficient method for transmitting and receiving a channel and a signal in the 5G communication system corresponding to the above-described embodiment. However, the components of the base station 1600 according to an embodiment are not limited to the above-described example and the base station 1600 may include fewer components than or additional components than the above-described components. In addition, the transceiver 1601, the controller 1602, and the storage unit 1603 may be implemented in the form of a single chip.

The transceiver 1601 may also include a transmitter and a receiver that may transmit/receive a signal to/from a UE. The signal may include control information and data. To this end, the transceiver 1601 may include an RF transmitter for up-converting and amplifying a frequency of a transmitted signal, and an RF receiver for low-noise amplifying and down-converting a received signal. In addition, the transceiver 1601 may receive a signal through a wireless channel to output the received signal to the controller 1602 and transmit the signal output from the controller 1602 through a wireless channel.

The controller 1602 may control a series of processes in which the base station 1600 may operate. For example, the controller 1602 may perform or control the operation of the base station for performing a UL channel transmitting method for random access. To this end, the controller 1602 may include a CP for performing control for communication, and an AP for controlling a higher layer, such as an application program.

The storage unit 1603 may store data or control information such as information related to channel estimates using DMRS transmitted from the PUSCH determined by the base station 1600 or data or control information received from the UE, and may include an area for storing data required for the control by the controller 1602 and data generated during the control by the controller 1602.

Herein, it is understood that each block and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction indicates that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been particularly shown and described with reference to embodiments thereof, it will be understood by those skilled in the art that various changes in form and details may be made therein without departing from the scope of the subject matter as defined by the appended claims and their equivalents.

What is claimed is:

1. A method performed by a user equipment (UE) in a communication system, the method comprising:
receiving, from a base station, information on a reference signal receive power (RSRP) threshold associated with a message 3 (Msg3) repetition;
identifying an RSRP of a downlink pathloss reference;
determining whether RSRP repetition is applicable based on the RSRP threshold and the RSRP of the downlink pathloss reference; and
transmitting the Msg3 to the base station according to the determination.

2. The method of claim 1,
wherein the RSRP repetition is determined to be applicable in case that the RSRP of the downlink pathloss reference is less than the RSRP threshold.

3. The method of claim 1,
wherein the RSRP repetition is determined to be not applicable in case that the RSRP of the downlink pathloss reference is greater than or equal to the RSRP threshold.

4. The method of claim 1,
wherein the information on the RSRP threshold associated with the Msg 3 repetition is received via a higher layer signaling.

5. A method performed by a base station in a communication system, the method comprising:
transmitting, to a user equipment (UE), information on a reference signal receive power (RSRP) threshold associated with a message 3 (Msg3) repetition; and
receiving, from the UE, the Msg3 according to whether RSRP repetition is applicable determined based on the RSRP threshold and an RSRP of downlink pathloss reference.

6. The method of claim 5,
wherein the RSRP repetition is determined to be applicable in case that the RSRP of the downlink pathloss reference is less than the RSRP threshold.

7. The method of claim 5,
wherein the RSRP repetition is determined to be not applicable in case that the RSRP of the downlink pathloss reference is greater than or equal to the RSRP threshold.

8. The method of claim 5,
wherein the information on the RSRP threshold associated with the Msg 3 repetition is transmitted via a higher layer signaling.

9. A user equipment (UE) in a communication system, the UE comprising:
a transceiver; and
a controller configured to:
receive, from a base station, information on a reference signal receive power (RSRP) threshold associated with message 3 (Msg3) repetition,
identify an RSRP of a downlink pathloss reference,
determine whether RSRP repetition is applicable based on the RSRP threshold and the RSRP of the downlink pathloss reference, and
transmit the Msg3 to the base station according to the determination.

10. The UE of claim 9,
wherein the RSRP repetition is determined to be applicable in case that the RSRP of the downlink pathloss reference is less than the RSRP threshold.

11. The UE of claim 9,
wherein the RSRP repetition is determined to be not applicable in case that the RSRP of the downlink pathloss reference is greater than or equal to the RSRP threshold.

12. The UE of claim 9,
wherein the information on the RSRP threshold associated with the Msg 3 repetition is received via a higher layer signaling.

13. A base station (BS) in a communication system, the base station comprising:
a transceiver; and
a controller configured to:
transmit, to a user equipment (UE), information on a reference signal receive power (RSRP) threshold associated with a message 3 (Msg3) repetition, and
receive, from the UE, the Msg3 according to whether RSRP repetition is applicable determined based on the RSRP threshold and an RSRP of a downlink pathloss reference.

14. The BS of claim 13,
wherein the RSRP repetition is determined to be applicable in case that the RSRP of the downlink pathloss reference is less than the RSRP threshold.

15. The BS of claim 14,
wherein the RSRP repetition is determined to be not applicable in case that the RSRP of the downlink pathloss reference is greater than or equal to the RSRP threshold.

16. The BS of claim 15,
wherein the information on the RSRP threshold associated with the Msg 3 repetition is transmitted via a higher layer signaling.
